(19) United States
(12) Patent Application Publication
(10) Pub. No.: US 2016/0259803 A1
(43) Pub. Date: Sep. 8, 2016

(54) FOLDER MANAGEMENT METHOD AND INTELLIGENT TERMINAL

(71) Applicants: Hisense Mobile Communications Technology Co., Ltd., Qingdao (CN); Hisense USA Corp., Suwanee, GA (US); Hisense International Co., Ltd., Qingdao (CN)

(72) Inventor: Peng JIA, Qingdao (CN)

(73) Assignees: HISENSE MOBILE COMMUNICATIONS TECHNOLOGY CO., LTD., Qingdao (CN); HISENSE INTERNATIONAL CO., LTD., Qingdao (CN); HISENSE USA CORP., Suwanee, GA (US)

(21) Appl. No.: 14/940,952

(22) Filed: Nov. 13, 2015

(30) Foreign Application Priority Data
Mar. 3, 2015 (CN) 201510094840.3

(51) Int. Cl. G06F 17/30; G06F 3/0482; G06F 3/0484; G06F 3/0481

(52) U.S. Cl. CPC G06F 17/30126; G06F 3/04817; G06F 3/0482; G06F 3/04842

(57) ABSTRACT

A folder management method and an intelligent terminal are provided for conveniently and rapidly managing folders and improving user experience. The intelligent terminal acquires a set of folders, where the set of folders includes at least two folders. The intelligent terminal displays a first folder in the set of folders. The intelligent terminal receives a first operational instruction from a user, where the first operational instruction is configured to switch the first folder to a second folder in the set of folders. The first operational instruction includes an identification of the second folder. The intelligent terminal displays the second folder according to the identification of the second folder.

### CROSS-REFERENCE TO RELATED APPLICATION

This application claims priority to Chinese Patent Application No. 201510094840.3, filed on Mar. 3, 2015, which is hereby incorporated by reference in its entirety.

### TECHNICAL FIELD

The present disclosure relates to the field of folder management technologies, and in particular, to a folder management method and an intelligent terminal.

### BACKGROUND

With continuous development of the Internet industry, in the field of intelligent mobile terminals, many third party applications that are run on intelligent mobile terminals are springing out, so to satisfy requirements of users in different industries and fields. A user gets third party applications of interest via various ways and installs the applications in an intelligent mobile terminal. As a result, many third party applications are accumulated on an interface of the intelligent mobile terminal. To make the interface concise, the user may group the third party applications by using various classifying tools, so as to group the applications into different folders.

Assuming that the user groups the third party applications into N folders, the user needs to check the folders one by one when the user wants to check which third party applications are in the N folders, respectively. Specifically, if the N folders are located in one same interface, a first folders is clicked to check third party applications included in the folder, the interface is returned after the check is finished, then a second folder is clicked to check third party applications included in the folder, the interface is again returned after the check is finished, and in turn, a next folder is clicked and checked. Furthermore, if the N folders are not located in the same interface, after the folders in the current interface are clicked and checked, another interface needs to be switched to, so that folders in the other interface can be clicked and checked.

In the implementation of the process of checking the folders, the inventor found that the prior art at least has the following problems: a user needs to switch between each folder and page and also needs to click each folder one by one, so that third party applications included in the folder can be checked, resulting in complicate operations and poor user experience.

### SUMMARY

Embodiments of the present disclosure provide a folder management method and an intelligent terminal, for conveniently and rapidly managing folders and improving user experience.

In a first aspect of the present disclosure, a folder management method is provided. The method includes: acquiring a set of folders, where the set of folders includes at least two folders; displaying a first folder in the set of folders; receiving a first operational instruction from a user, where

the first operational instruction is configured to switch the first folder to a second folder in the set of folders, and the first operational instruction includes an identification of the second folder; and displaying the second folder according to the identification of the second folder.

In a second aspect of the present disclosure, an intelligent terminal is provided. The intelligent terminal includes: an acquiring circuitry, configured to acquire a set of folders, where the set of folders includes at least two folders; a displaying circuitry, configured to display a first folder in the set of folders; a receiving circuitry, configured to receive a first operational instruction from a user, where the first operational instruction is configured to switch the first folder to a second folder in the set of folders, and the first operational instruction includes an identification of the second folder. The displaying circuitry is further configured to display the second folder according to the identification of the second folder.

In the folder management method and the intelligent terminal provided in the embodiments of the present disclosure, by acquiring a set of folders that includes at least two folders, receiving a first operational instruction from a user when a first folder in the set of folders is in displayed state, and switching from the first folder to a second folder according to the first operational instruction, the user may directly switch among a plurality of folders without switching back and forth between folders and pages, as is the case in the prior art, so as to conveniently and rapidly manage the folders and improve user experience.

### BRIEF DESCRIPTION OF THE DRAWINGS

To illustrate the technical solutions in the embodiments of the present disclosure more clearly, the following briefly introduces the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a schematic diagram of a folder management method provided by an embodiment of the present disclosure;

FIGS. 2A-2C illustrate a schematic diagram representation of an implementation of the folder management method provided by the embodiment of the present disclosure;

FIG. 3 is a schematic diagram of another folder management method provided by an embodiment of the present disclosure;

FIG. 4A-4D illustrate a schematic diagram representation of an implementation of another folder management method provided by the embodiment of the present disclosure;

FIGS. 5A-5C illustrate a schematic diagram representation of transfer of an application icon in a folder provided by an embodiment of the present disclosure;

FIG. 6 is a schematic diagram of an intelligent terminal provided by an embodiment of the present disclosure; and

FIG. 7 is a schematic diagram of another intelligent terminal provided by an embodiment of the present disclosure.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. section 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue.

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

In the description of the present disclosure, it should be understand that positions and positional relationships indicated by the terms such as “center”, “above”, “below”, “in front of”, “behind”, “left”, “right”, “vertical”, “horizontal”, “top”, “bottom”, “inside”, “outside” are based on the position or positional relationship shown in the accompany drawings, which are used only for convenient and brief description, and do not indicate or imply that the indicated apparatus or element must be in a specific position, and must be constructed and operated in a specific position. In addition, in embodiments of the present disclosure, an inner end and an outer end are both defined according to directions of signals in a transmission path, that is, according to directions of signals in a transmission path, one end for inputting signals is defined as the outer end or a signal input end of the transmission path, and another end for outputting signals is defined as the inner end or a signal output end. Of course, other names may be defined according to principles, and thus the foregoing cannot be understood as a limitation on the present disclosure.

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

In the description of the present disclosure, it should be understood that the directions or position relationships indicated by terms such as “center”, “up”, “down”, “front”, “back”, “left”, “right”, “vertical”, “horizontal”, “top”, “bottom”, “inside”, and “outside” are directions or position relationships based on the accompanying drawings, and are only used for making it convenient to describe the present disclosure and simplifying the description, rather than indicate or imply that a referred apparatus or element must have a special direction, or be constructed and operated in a special direction, and therefore should not be constituted as limitation to the present disclosure.

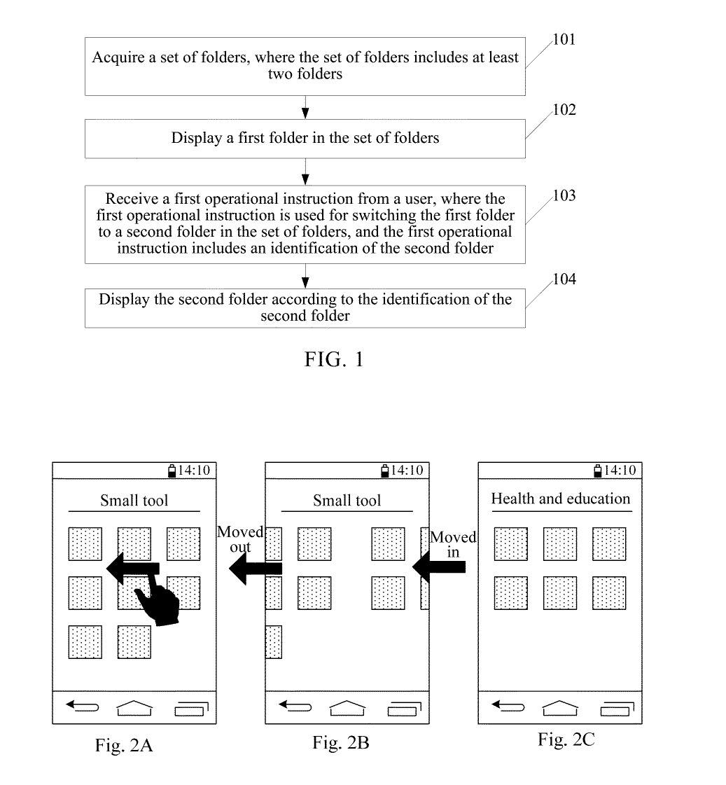

The embodiments of the present disclosure provide a folder management method. The folder management method may be implemented in an intelligent terminal. As shown in FIG. 1, the method includes:

Step 101: Acquire a set of folders, where the set of folders includes at least two folders.

An existing smart phone is used as an example. A user may pre-install a plurality of application in the smart phone. These applications are displayed in a page of the mobile phone in form of icons. The page of the mobile phone may appear messy when there are many installed applications. To facilitate use, the user may sort the installed application by hand or by using some classifying software, so as to place the applications into different types of folders. In the embodiments of the present disclosure, the set of folders includes at least two of the different types of folders. Meanwhile, each of the folders in the embodiments of the present disclosure may include at least one application icon, or may be a blank folder.

If an intelligent terminal includes a plurality of pages and a folder is set on each page, the set of folders may include all folders in a current page, or may also include folders in all pages. Certainly, at least one folder in different pages may be placed in the set of folders according to settings of a user.

Step 102: Display a first folder in the set of folders.

For an existing intelligent terminal, when a user taps a certain folder on a touch screen of the intelligent terminal, the touch screen displays a name of the folder and an icon of an application included in the folder. If the folder is a blank folder, only the name of the folder is displayed.

Step 103: Receive a first operational instruction from a user, where the first operational instruction is configured to switch the first folder to a second folder in the set of folders, and the first operational instruction includes an identification of the second folder.

Step 104: Display the second folder according to the identification of the second folder.

For step 103 and step 104, the switching from the first folder to the second folder may be implemented by using two different ways. Details of the two solutions are described below.

In the first solution, the first operational instruction is a slip operation. An identification of the second folder corresponding to a direction of the slip operation is acquired according to the direction of the slip operation. The second folder is a folder adjacent to the first folder in a preset sequence. For example, the switch between the folders may be implemented by slipping towards left or right.

To describe the foregoing solution clearer, it is assumed that the intelligent terminal includes 5 folders, which are entertainment, sport, small tool, health education, and living and diet, sequentially. As shown in FIG. 2(a), if the small tool folder is in interface displayed state, upon receipt of an instruction of slipping towards left from a user by the intelligent terminal when the user touches a blank position in the small tool folder and then slips towards left, as shown in FIG. 2(b), content of the current small tool folder fades out towards left along with a finger, and at the same time, content of the health education folder that is adjacent to the small tool folder fades in the interface in which the current small toll folder is displayed. When the content of the health education folder is completely moved in, a name of the health education folder that is moved in is displayed, as shown in FIG. 2(c). With the same reasons, upon receipt of an instruction of slipping towards right from a user by the intelligent terminal when the user touches a blank position in the small tool folder and then slips towards right, content of the current small tool folder fades out towards right along with a finger, and at the same time, content of the sport folder that is adjacent to the small tool folder fades in the interface in which the current small toll folder is displayed. When the content of the sport folder is completely moved in, a name of the sport folder that is moved in is displayed.

According to the foregoing solution, when content of a certain folder is in displayed state, switch between different folders may be implemented by slipping towards left/right without returning to a desktop multiple times, so that content included in different folders can be checked, as is the case in the prior art.

Certainly, there is no effect by slipping towards right when content in the entertainment folder is in displayed state, and the content of the entertainment folder is still displayed. With the same reasons, there is no effect by slipping towards left when content in the living and diet folder is in displayed state, and the content of the living and diet folder is still displayed.

In the second solution, the intelligent terminal directly switches from a first folder that is in displayed state to a second folder according to an identification of the second folder to which a user selects to switch.

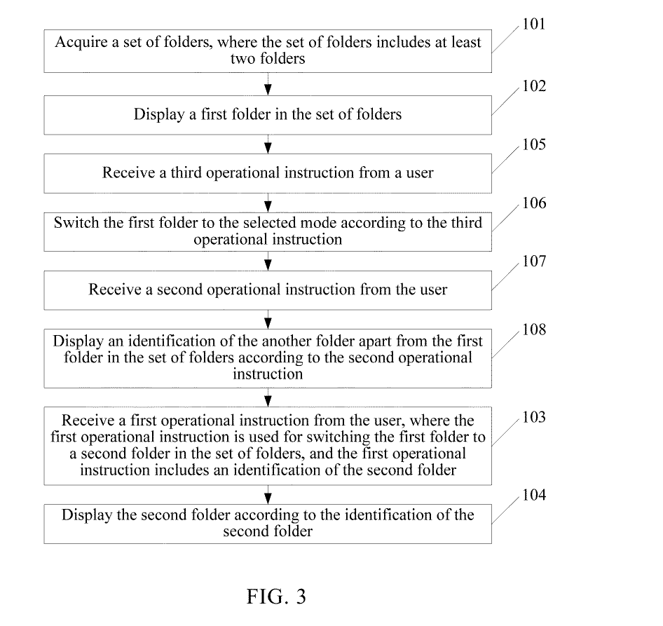

Specifically, as shown in FIG. 3, before step 103: receive a first operational instruction from a user, the method further includes:

Step 105: Receive a third operational instruction from a user.

The third operational instruction is configured to switch the first folder to a selected mode. The selected mode includes a triggering icon.

Step 106: Switch the first folder to the selected mode according to the third operational instruction.

Step 107: Receive a second operational instruction from the user.

The second operational instruction is configured to display an identification of the another folder apart from the first folder in the set of folders. The user may execute the second operational instruction by tapping the triggering icon.

Step 108: Display an identification of the remaining folder apart from the first folder in the set of folders according to the second operational instruction.

After step 108 is performed, continuously perform step 103: receive a first operational instruction from the user, where the first operational instruction includes an identification of the second folder selected by the user, further, directly switch from the first folder to the second folder according to the identification of the second folder, and display the second folder.

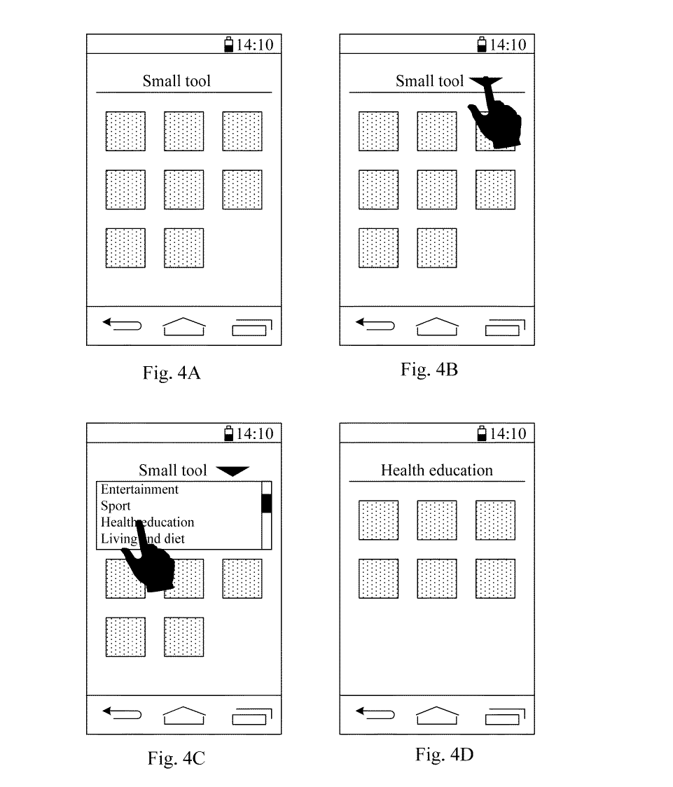

To describe the second solution clearer, the identification of the second folder being a name of the second folder is used as an example for describing. As shown in FIG. 4(a), when the small tool folder is in interface displayed state, a user taps a name “small tool” of the folder, and the intelligent terminal displays the folder name in form of a pull-down list with an arrow, for example, a black arrow shown in FIG. 4(b), after receiving a tapping instruction from the user. The user then taps the arrow, and a touch screen displays a name of another folder apart from the small tool folder in the set of folders, for example, entertainment, sport, health education, and living and diet shown in FIG. 4(c). Further, the user taps any displayed folder name, and a terminal device switches to content of a folder selected by the user according to a name of the folder selected by the user. If the user selects the health education, the content in the small tool folder that is displayed currently is switched to content in the health education folder.

Further, on the basis of the first solution, when the user long-presses the icon of the first application in the first folder, the terminal device detects whether a time for which the icon of the first application is pressed exceeds a preset time. The detecting of whether the time for which the icon of the first application is pressed exceeds the preset time is majorly for detecting whether the user is long-pressing the application icon so as to determine whether the user needs to perform a transfer operation on the application icon. If it is detected that the time for which the first application in the first folder is pressed exceeds the preset time, the pressed application icon may be dragged to transfer to the second folder when the user slipping towards left/right.

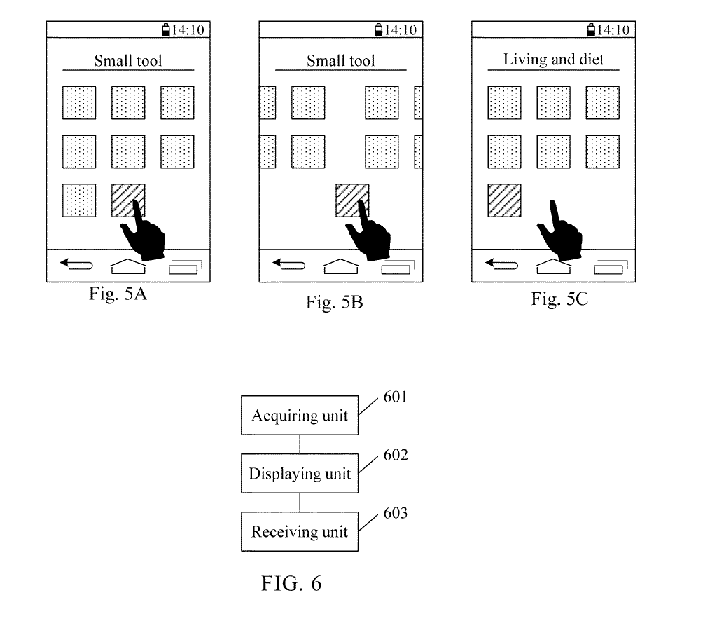

For example, assuming that it is detected that a time for which an icon of a “clock” application (the part filled with oblique lines in FIG. 5) in the small tool folder is pressed exceeds a preset time, which can be set by a manufacturer of the intelligent terminal, the application icon is dragged to move towards right (as shown in FIG. 5(b)) and the small tool folder in displayed state is switched to the health education folder. If the user wants to place the icon of the “clock” application in the health education folder, the user may release fingers upon switch to the health education folder, and the icon of the “clock” application is transferred to the health education folder. If the user wants to place the icon of the “clock” application in the living and diet folder, the user may continuously drag the application icon to move towards right and does not release fingers until the living and diet folder is switched to (as shown in FIG. 5(c)), and the icon of the “clock” application is transferred to the living and diet folder.

In the folder management method provided in the embodiments of the present disclosure, by acquiring a set of folders, receiving a first operational instruction from a user when a first folder in the set of folders is in displayed state, and switching from the first folder to a second folder according to the first operational instruction, the user may directly switch among a plurality of folders without switching back and forth between folders and pages, as is the case in the prior art, so as to conveniently and rapidly manage the folders and improve user experience.

The embodiments of the present disclosure provide a method for managing folders. The switch between folders by using a slip operation in Embodiment 1 is used as an example.

For an intelligent terminal, the intelligent terminal first stores all data, including targets such as application icons and folders, in a database. The data in the database may be filtered. All folder targets are obtained through filtering and stored in a set. The set is stored in a memory as static data. The filtered set (a set that only stores folder targets) is read for use when folder switching is performed. The set that only stores folder targets is referred to as a set of folders for subsequent description.

When a first folder in the set of folders is in displayed state, an identification of a second folder that is adjacent to the first folder is acquired according to an operation of slipping towards left if the operation of slipping towards left by a user is received. Certainly, the identification of the second folder is acquired according to the direction of slipping towards left. The identification is a folder name of the second folder. Further, switching from the first folder to the second folder is performed according to the folder name of the second folder. If an operation of slipping towards right by a user is received, a folder name of a second folder that is adjacent to the first folder is acquired according to the operation of slipping towards right. Certainly, the folder name of the second folder is acquired according to the operation of slipping towards right. Further, switching from the first folder to the second folder is performed according to the folder name of the second folder.

During the slipping, the acquire identification of the second folder may be the folder name of the second folder, or may also be another identification capable of indicating a different folder. For example, a different folder may be indicated by using a letter, a numeral, or a combination of a letter and a numeral.

In the folder management method provided in the embodiments of the present disclosure, by acquiring a set of folders, receiving a first operational instruction from a user when a first folder in the set of folders is in displayed state, and switching from the first folder to a second folder according to the first operational instruction, the user may directly switch among a plurality of folders without switching back and forth between folders and pages, as is the case in the prior art, so as to conveniently and rapidly manage the folders and improve user experience.

The embodiments of the present disclosure further provide an intelligent terminal. As shown in FIG. 6, the intelligent terminal includes:

an acquiring unit 601, configured to acquire a set of folders, where the set of folders includes at least two folders;

a displaying unit 602, configured to display a first folder in the set of folders;

a receiving unit 603, configured to receive a first operational instruction from a user, where the first operational instruction is used for switching the first folder to a second folder in the set of folders, and the first operational instruction includes an identification of the second folder.

The displaying unit 602 is further configured to display the second folder according to the identification of the second folder.

Optionally, the first operational instruction is a slip operation. The corresponding identification of the second folder is acquired according to a direction of the slip operation. The second folder is adjacent to the first folder.

Optionally, the receiving unit 603 is further configured to, before receiving a first operational instruction from a user, receive a second operational instruction from the user. The second operational instruction is used for displaying an identification of another folder apart from the first folder in the set of folders.

The displaying unit 602 is further configured to display the identification of the another folder apart from the first folder in the set of folders according to the second operational instruction.

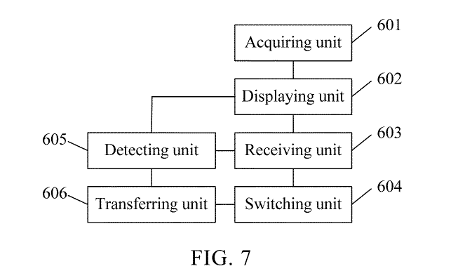

Optionally, as shown in FIG. 7, the intelligent terminal further includes: a switching unit 604.

The receiving unit 603 is further configured to, before receiving a second operational instruction from the user, receive a third operational instruction from the user. The third operational instruction is used for switching the first folder to a selected mode. The selected mode includes a triggering icon for the user to perform the second operational instruction.

The switching unit 604 is configured to switch the first folder to the selected mode according to the third operational instruction.

Optionally, as shown in FIG. 7, the intelligent terminal further includes: a detecting unit 605 and a transferring unit 606.

The detecting unit 605 is configured to, before the receiving unit 603 receives a first operation from a user, detect whether a time for which an icon of a first application in the first folder is pressed exceeds a preset time.

The receiving unit 603 is further configured to receive the first operational instruction from the user if the detecting unit 605 detects that the time for which the first application in the first folder is pressed exceeds the preset time.

The transferring unit 606 is configured to, after the displaying unit 602 displays the second folder according to the identification of the second folder, transfer the icon of the first application to the second folder.

Optional, the set of folders includes folders in a page in which the first folder is located, or, the set of folders includes folders in all pages.

In the intelligent terminal provided by the embodiments of the present disclosure, by acquiring a set of folders, receiving a first operational instruction from a user when a first folder in the set of folders is in displayed state, and switching from the first folder to the second folder according to the first operational instruction, the user may directly switch among a plurality of folders without switching back and forth between folders and pages, as is the case in the prior art, so as to conveniently and rapidly manage the folders and improve user experience.

It should be understood that, in the several embodiments provided in the present application, the system, apparatus, and method described all may be implemented by using other methods. For example, the foregoing described apparatus embodiments are only schematic. For example, the division of the units is only logic functional division, and another dividing method may be used during actual implementation. For example, a plurality of units or components may be combined or may be integrated into another system, or some features may be neglected or not be executed. For another point, the displayed or discussed mutual coupling, direct coupling, or communication connection may be indirect coupling or communication connection via some interfaces, apparatuses, or units, which may be electrical, mechanical, or in other forms.

The units described as separated parts may be or may not be physically separated, and the parts displayed as units may be or may not be physical units, that is, the units may be located at one same position, or may also be distributed to a plurality of network units. Some or all units may be selected to implement the objective of the solution of this embodiment according to actual needs.

Besides, all functional units in the embodiments of the present disclosure may be integrated in one processing unit, each unit may also be included alone physically, or two or more units are integrated into one unit. The units may be implemented by using hardware such as a circuitry, a hardware processor, etc. Additionally or alternatively, the units may also be implemented by using hardware and software functional units.

The foregoing integrated unit implemented in form of software functional units may be stored in a computer readable memory. The foregoing software functional units are stored in a memory, including several instructions for instructing a computer device (which may be a personal computer, a server, or a network device) to execute some steps of the method of the embodiments of the present disclosure. The foregoing memory includes: various media capable of storing program codes such as a U flash disk, a mobile hard disk, a read-only memory (ROM), a random access memory (RAM), a magnetic disk, or an optical disk.

Finally, it should be noted that: the foregoing embodiments are only used for describing the technical solutions of the present disclosure, rather than limit the present disclosure. Although the present disclosure is described in detail with reference to the foregoing embodiments, a person skilled in the art should understand that: the technical solutions described in the foregoing embodiments can be further amended, or equivalent replacements may be performed on some technical features thereof; however, these modifications or replacements do not make the corresponding technical solutions substantially depart from the spirit and scope of the technical solutions of the embodiments of the present disclosure.

What is claimed is:

1. A folder management method, comprising:
acquiring a set of folders, wherein the set of folders comprise at least two folders;
displaying a first folder in the set of folders;
receiving a first operational instruction, wherein the first operational instruction is configured to switch the first folder to a second folder in the set of folders, and the first operational instruction comprises an identification of the second folder; and
displaying the second folder according to the identification of the second folder.

2. The method according to claim 1, wherein the first operational instruction comprises a slip operation, the corresponding identification of the second folder is acquired according to a direction of the slip operation, and the second folder is adjacent to the first folder.

3. The method according to claim 1, wherein before receiving the first operational instruction, the method further comprises:
receiving a second operational instruction, wherein the second operational instruction is configured to display an identification of another folder apart from the first folder in the set of folders; and
displaying the identification of the another folder apart from the first folder in the set of folders according to the second operational instruction.

4. The method according to claim 3, wherein before the receiving a second operational instruction, the method further comprises:
receiving a third operational instruction, wherein the third operational instruction is configured to switch the first folder to a selected mode, and the selected mode comprises a triggering icon for a user to perform the second operational instruction; and
switching the first folder to the selected mode according to the third operational instruction.

5. The method according to claim 1, further comprising:
detecting whether a time for which an icon of a first application in the first folder is pressed exceeds a preset time;
receiving the first operational instruction when the time for which the first application in the first folder is pressed exceeds the preset time; and
transferring the icon of the first application to the second folder.

6. The method according to claim 1, wherein the set of folders comprise folders in a page in which the first folder is located, or, the set of folders comprise folders in all pages.

7. An intelligent terminal, comprising:
an acquiring circuitry, configured to acquire a set of folders, wherein the set of folders comprise at least two folders;
a displaying circuitry, configured to display a first folder in the set of folders;
a receiving circuitry, configured to receive a first operational instruction from a user, wherein the first operational instruction is configured to switch the first folder to a second folder in the set of folders, and the first operational instruction comprises an identification of the second folder; and
wherein the displaying circuitry is further configured to display the second folder according to the identification of the second folder.

8. The intelligent terminal according to claim 7, wherein:
the receiving circuitry is further configured to, before receiving a first operational instruction from a user, receive a second operational instruction, wherein the second operational instruction is configured to display an identification of another folder apart from the first folder in the set of folders; and
the displaying circuitry is further configured to display the identification of the another folder apart from the first folder in the set of folders according to the second operational instruction.

9. The intelligent terminal according to claim 8, wherein the intelligent terminal further comprises: a switching circuitry; wherein:
the receiving circuitry is further configured to, before receiving a second operational instruction, receive a third operational instruction, wherein the third operational instruction is configured to switch the first folder to a selected mode, and the selected mode comprises a triggering icon for a user to perform the second operational instruction; and
the switching circuitry is configured to switch the first folder to the selected mode according to the third operational instruction.

10. The intelligent terminal according to claim 7, wherein the intelligent terminal further comprises: a detecting circuitry and a transferring circuitry; wherein:
the detecting circuitry is configured to, before the receiving circuitry receives a first operation from a user, detect whether a time for which an icon of a first application in the first folder is pressed exceeds a preset time;
the receiving circuitry is further configured to receive the first operational instruction if the detecting circuitry detects that the time for which the first application in the first folder is pressed exceeds the preset time; and
the transferring circuitry is configured to, after the displaying circuitry displays the second folder according to the identification of the second folder, transfer the icon of the first application to the second folder.
